(19) United States
(12) Patent Application Publication
(10) Pub. No.: US 2005/0279020 A1
(43) Pub. Date: Dec. 22, 2005

(54) Hermetic plant cultivating apparatus being free-from-irrigation

(75) Inventor: Chia-Hsun Hsu, Kaohsiung City (TW)

Correspondence Address: BACON & THOMAS, PLLC, 625 SLATERS LANE, FOURTH FLOOR, ALEXANDRIA, VA, 22314, US

(73) Assignees: Chia-Hsun Hsu, Kaohsiung City (TW); Mei-Man Chen, Kaohsiung City (TW)

(21) Appl. No.: 11/155,718

(22) Filed: Jun. 20, 2005

(30) Foreign Application Priority Data
Jun. 21, 2004 (TW) 093118027

(51) Int. Cl. A01G 9/14

(52) U.S. Cl. 47/17

(57) ABSTRACT

A hermetic plant cultivating apparatus being free-from-irrigation to allow a cultivated plant being disposed inside of the hermetic container for long-term cultivation without necessity of supplying water again. The way is mainly by means of laying the soil layer at the undermost inside of a transparent hermetic cultivating container being pervious to light, and to top-cover a turf layer above such soil layer, then to root the cultivated plant into such soil layer and such turf layer. The adequate water quantity first supplied at the start in such cultivating container can be recycling used as the vapor created by the sun irradiation being kept inside without diffusion or drain. And, the oxygen carried in such water can be fed to such cultivated plant. Thus, the expected effect of being free-from-irrigation in long-term during cultivating term can be achieved, so that having inestimable industrial application value.

### FIELD OF THE INVENTION

The present invention relates to an originating plant cultivating apparatus, particularly a hermetic plant cultivating apparatus being free-from-irrigation to allow a cultivated plant being disposed inside of the hermetic container for long-term cultivation without necessity of supplying water again.

### BACKGROUND OF THE INVENTION

Currently, the conventional plant cultivating apparatus for long-term growing the cultivated plant inside the container is to lay the soil layer at the undermost, and to top-cover a turf layer above such soil layer, then to root the cultivated plant into such soil layer and such turf layer.

And, such cultivating apparatus is uncovered container with top open in order to get sunshine and air as well as to conveniently supply water regularly in everyday to sustain such cultivated plant in growth expectably.

But the container of the plant cultivating apparatus construction mentioned above, the water in it would be decrease due to loss in evaporation. Therefore, water should be regularly supplied in everyday to sustain the cultivated plant in normal growth.

However, the frequency and period of the water supplying will change in accordance with the difference of the ambient temperature and humidity in the location of such apparatus put. Once the discontinuity of the water supplying due to being busy will cause such cultivating container lack of water in consequence of affecting the growth of such cultivated plant and even result in un-survival either.

This situation always happens in the household horticulturist of the gardening for enjoyment of sight and causes bothering.

### SUMMARY OF THE PRESENT INVENTION

The present invention originates a hermetic plant cultivating apparatus being free-from-irrigation to allow a cultivated plant being disposed inside of the hermetic container for long-term cultivation without necessity of supplying water again. The way is by means of laying the soil layer at the undermost inside of a transparent hermetic cultivating container being pervious to light, and to top-cover a turf layer above such soil layer, then to root the cultivated plant into such soil layer and such turf layer.

The adequate water quantity first supplied at the start in such cultivating container can be recycling used as the vapor created by the sun irradiation being kept inside without diffusion or drain. And, the oxygen carried in such water can be fed to such cultivated plant. Thus, the expected effect of being free-from-irrigation in long-term during cultivating term can be achieved, so that having inestimable industrial application value. That is the primal object of the present invention.

The other object in the present invention of the hermetic plant cultivating apparatus being free-from-irrigation is directly used in farming the cultivated plant inside of such cultivating container. Wherein the adequate water quantity first supplied at the start in such transparent hermetic cultivating container being pervious to light can be recycling used as the vapor created by the sun irradiation being kept inside without diffusion or drain. And, the oxygen carried in such water can be fed to such cultivated plant. Thus, the expected effect of being free-from-irrigation in long-term during cultivating term can be achieved; so that having inestimable industrial application value in hydroponics.

### BRIEF DESCRIPTION OF THE DRAWINGS

FIG. 1 is a perspective view of the first preferred embodiment of the present invention.

FIG. 2 is a lateral cross sectional view of the FIG. 1

FIG. 3 is a perspective view of the second preferred embodiment of the present invention.

FIG. 4 is a perspective view of the third preferred embodiment of the present invention.

FIG. 5 is a partial perspective view of the FIG. 4

### DETAILED DESCRIPTION OF THE PREFERRED EMBODIMENT

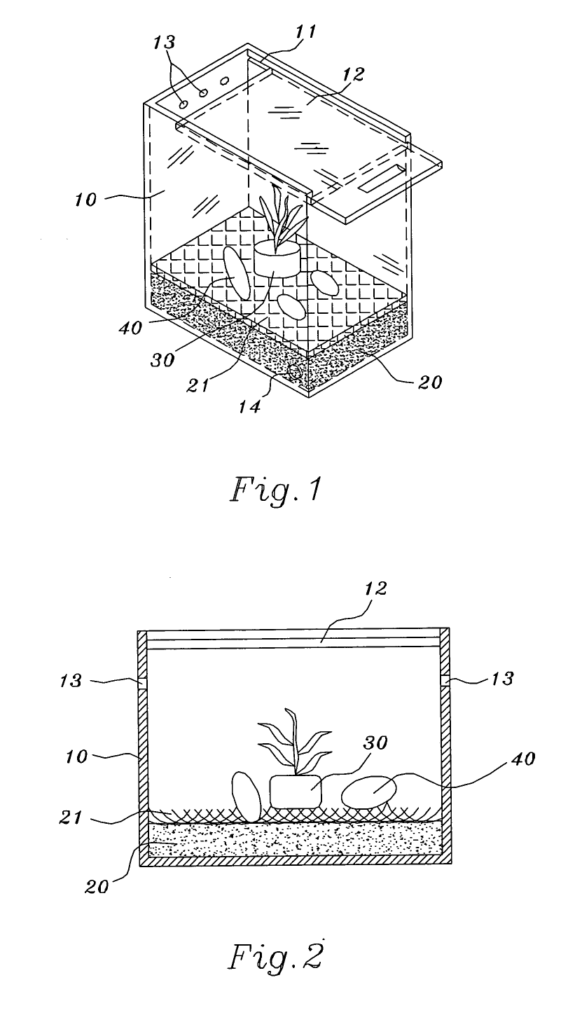

Referring to FIG. 1 and FIG. 2, the present invention of hermetic plant cultivating apparatus being free-from-irrigation comprises a box body 10 with a top sliding lid 12, a soil layer 20 being topped with a turf layer 21, a cultivated plant 30 and a decorative article 40.

Wherein said box body 10 is made of transparent material being pervious to light into an uncovered hollow container with top open, and near to its upper end, a pair of transverse sliding chute 11 is formed on the inner sides of the opposing walls. A plurality of tiny porous holes 13 is created adjacent and beneath to said transverse sliding chute 11. Additionally, near to its lower end in one wall of said box body 10, a drain aperture 14 is shaped and being blocked when not in drain.

A planar transparent top sliding lid 12 being made of material pervious to light is removable engaged with said transverse sliding chute 11 mentioned above said that it being able to slide to and fro. Thus it allows the upper end of said box body 10 operating in selectable open or shut condition.

A soil layer 20 is laid at the undermost inside of said box body 10.

A turf layer 21 top-covers above said soil layer 20 inside of said box body 10.

A cultivated plant 30 of indoor potted plant accompanying with its pot is put on said turf layer 21.

A decorative article 40 is put in any position on said turf layer 21 either in movable or fixed way.

Said tiny porous holes 13 can also be blocked by other hard plug-like object, and can be opened when exhausting the vapor is necessary.

By assembly of all elements aforesaid, said drain aperture 14 near to the lower end of said box body 10 and said tiny porous holes 13.near to the upper end of said box body 10 are blocked. Then said top sliding lid 12 is put to shut the top opening of said box body 10, so that said box body 10 becomes a hermetic hollow compartment. The existing water can be recycling used as the vapor created by the sun irradiation being kept inside without diffusion or drain (as illustrated in the attached pictures of life-object sample in embodiments). And, the oxygen carried in such water can be fed to said cultivated plant 30. Thus, the expected effect of being free-from-irrigation in long-term during cultivating term can be achieved, so that having inestimable industrial application value.

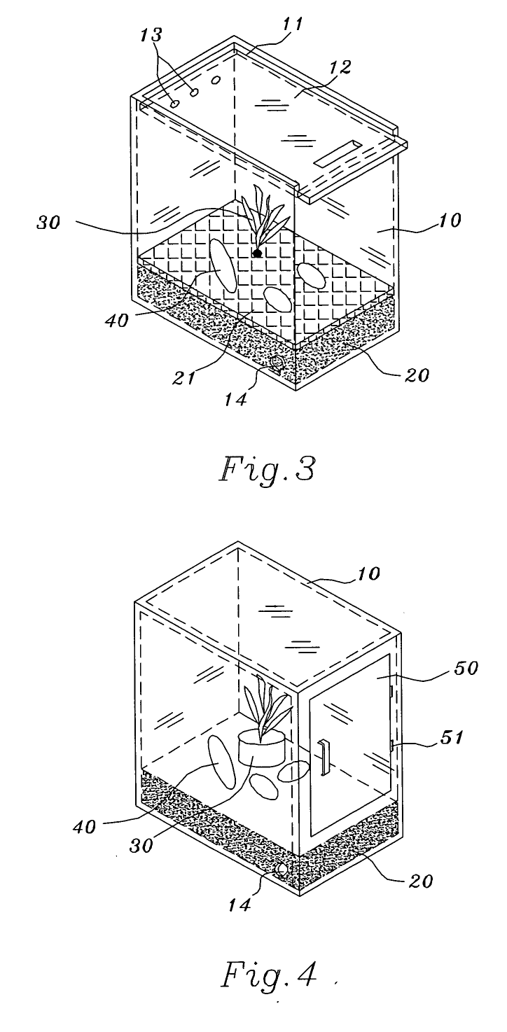

Referring to FIG. 3, the second preferred embodiment of the present invention is to directly root the cultivated plant 30 without pot into said turf layer 21 and said soil layer 20, such that becoming “hydroponics” farming way. Then, said cultivated plant 30 including edible and non-edible plants can also be applicable in such hermetic plant cultivating apparatus.

By assembly of all elements aforesaid, said drain aperture 14 near to the lower end of said box body 10 and said tiny porous holes 13 near to the upper end of said box body 10 are blocked. Next, the adequate water is supplied in such manner of that the water level is at least higher than absorbing portion in the root of said cultivated plant 30. Then said top sliding lid 12 is put to shut the top opening of said box body 10, so that said box body 10 becomes a hermetic hollow compartment. The existing water can be recycling used as the vapor created by the sun irradiation being kept inside without diffusion or drain. And, the oxygen carried in such water can be fed to said cultivated plant 30. Thus, the expected effect of being free-from-irrigation in long-term during cultivating term can be achieved.

In other words, the present invention has been experimented and tested innumerable times (as illustrated in the attached pictures of life-object sample in embodiments) with evidently positive results as expected effect, so that having inestimable industrial application value in hydroponics.

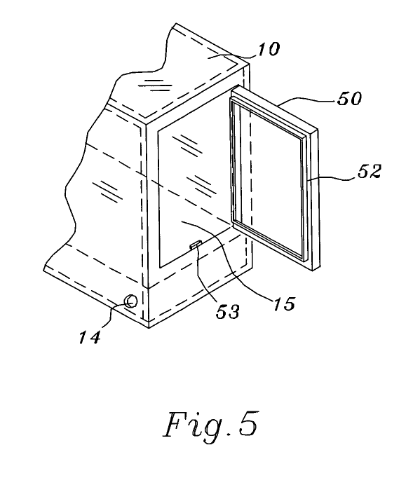

Referring to FIG. 4 and FIG. 5, the third preferred embodiment of the present invention is to cancel said top sliding lid 12 and replace it by an opening 15 with a flange 53 in any side of said box body 10.

A transparent side-open swing door 50 being made of material pervious to light is fixed on said opening 15 by means of a hinge 51 such that being able to shut or open said opening 15.

Moreover, a sealing bar 52 being made of elastic material is firmly attached on said side-open swing door 50 at the position corresponding to said flange 53 of said opening 15.

Thus, during shut condition of said side-open swing door 50, the hermetic function to said opening 15 can be achieved by said sealing bar 52, while said opening 15 serves as inlet and outlet of said cultivated plant 30.

In recapitulation, the present invention is applicable to any environment as long as it having sunshine in spite of the difference in the ambient temperature and humidity. Further, it can eliminate the worry about the discontinuity of the water supplying due to being busy will cause such cultivating container lack of water in consequence of affecting the growth of such cultivated plant and even result in un-survival either, so that having practical convenient effect.

1. A hermetic Plant Cultivating Apparatus being free-from-Irrigation comprising:
A box body having a inner hollow container and made of transparent material, in the top of said box body has a top opening and having a pair of transverse sliding chute which is formed on the inner sides of said top opening, in the bottom side of said box body further has a drain aperture and is blocked when not in;
A top sliding lid is removable in the transverse sliding chute of said box body and made of transparent material which being able to slide to and fro of said top opening of said box body;
A soil layer is laid at the undermost inside of said box body; and
A cultivated plant is rooted in a potting and said potting is laid on the top of said soil layer.

2. A hermetic Plant Cultivating Apparatus being free-from-Irrigation, as recited in claim 1, wherein said box body further having a plurality of tiny porous holes which is created adjacent and beneath to said transverse sliding chute, said tiny porous holes can also be blocked by other hard plug-like object, and can be opened when exhausting the vapor is necessary

3. A hermetic Plant Cultivating Apparatus being free-from-Irrigation, as recited in claim 1, wherein said cultivated plant is planted in said soil layer without a potting.

4. A hermetic Plant Cultivating Apparatus being free-from-Irrigation, as recited in claim 1, wherein said soil layer further has a top-covers of turf layer.

5. A hermetic Plant Cultivating Apparatus being free-from-Irrigation, as recited in claim 1, wherein said cultivated plant is planted between in said turf layer and soil layer.

6. A hermetic Plant Cultivating Apparatus being free-from-Irrigation, as recited in claim 4, wherein said cultivated plant is planted between in said turf layer and soil layer.

7. A hermetic Plant Cultivating Apparatus being free-from-Irrigation, as recited in claim 1, wherein said turf layer further has cover by a decorative article.

8. A hermetic Plant Cultivating Apparatus being free-from-Irrigation, as recited in claim 4, wherein said turf layer further has cover by a decorative article.

9. A hermetic Plant Cultivating Apparatus being free-from-Irrigation, as recited in claim 1, wherein said soil layer is a hydrous organic synthetic-artificial soil.

10. A hermetic Plant Cultivating Apparatus being free-from-Irrigation comprising:
A box body having a inner hollow container and made of transparent material, in the one of side of said box body has a side opening which is having a flange mounted thereon, in the bottom side of said box body further has a drain aperture and is blocked when not in;
A side-open swing door made of transparent material and fixed on said side opening by means of a hinge which being able to shut or open said side opening of said box body;
A sealing bar is firmly attached on said side-open swing door which is corresponding to said flange of said opening;
A soil layer is laid at the undermost inside of said box body; and
A cultivated plant is rooted in a potting and said potting is laid on the top of said soil layer.

11. A hermetic Plant Cultivating Apparatus being free-from-Irrigation, as recited in claim 1, wherein said box body further having a plurality of tiny porous holes which is created adjacent and beneath to said transverse sliding chute, said tiny porous holes can also be blocked by other hard plug-like object, and can be opened when exhausting the vapor is necessary.

12. A hermetic Plant Cultivating Apparatus being free-from-Irrigation, as recited in claim 1, wherein said cultivated plant is planted in said soil layer without a potting.

13. A hermetic Plant Cultivating Apparatus being free-from-Irrigation, as recited in claim 1, wherein said soil layer further has a top-covers of turf layer.

14. A hermetic Plant Cultivating Apparatus being free-from-Irrigation, as recited in claim 1, wherein said cultivated plant is planted between in said turf layer and soil layer.

15. A hermetic Plant Cultivating Apparatus being free-from-Irrigation, as recited in claim 4, wherein said cultivated plant is planted between in said turf layer and soil layer.

16. A hermetic Plant Cultivating Apparatus being free-from-Irrigation, as recited in claim 1, wherein said turf layer further has cover by a decorative article.

17. A hermetic Plant Cultivating Apparatus being free-from-Irrigation, as recited in claim 4, wherein said turf layer further has cover by a decorative article.

18. A hermetic Plant Cultivating Apparatus being free-from-Irrigation, as recited in claim 1, wherein said soil layer is a hydrous organic synthetic-artificial soil.
